(19) United States
(12) Patent Application Publication
(10) Pub. No.: US 2010/0293604 A1
(43) Pub. Date: Nov. 18, 2010

(54) INTERACTIVE AUTHENTICATION CHALLENGE

(75) Inventors: Arun K. Nanda, Sammamish, WA (US); Tariq Sharif, Issaquah, WA (US); Kim Cameron, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/465,701

(22) Filed: May 14, 2009

(51) Int. Cl. H04L 9/32; G06F 21/00

(52) U.S. Cl. 726/5; 726/9

(57) ABSTRACT

A system and method for authenticating a request for a resource. A requester sends the request for a resource to a server in a first protocol. The server may send a challenge message to the requester. In response, the requester employs a challenge handler that performs an interactive challenge with a challenge server in a second protocol. Upon successful conclusion of the interactive challenge, the challenge handler synchronizes with a request handler, which sends a challenge response message to the server. The server may then enable access to the requested resource.

### TECHNICAL FIELD

The present invention relates generally to network technology, and, more particularly, to interactive authentication of requests in a networked environment.

### BACKGROUND

Computer networks are subject to a variety of security breaches. One such type of breach occurs when a user or computer system falsely identifies itself, in order to access resources that it is not authorized to access, or to otherwise avoid being correctly associated with a request. To facilitate request authentication, a request for a resource to a relying party includes the identity of the requester in a manner such that the relying party can verify the authenticity of the identity. Request authentication is the process of verifying the identity of the sender of a request. Authentication provides some level of security that each party's identification is accurate. The identity of the requester forms the basis for access control decisions made by a relying party. It also enables a relying party to accurately attribute the request to the requester.

One type of request authentication includes the use of a username and password. A stronger type of authentication involves the use of a security token. Some types of security tokens are provided by a trusted identity provider. Possession of a security token serves to provide proof of identity for the possessing party. Some security tokens have embedded cryptographic keys for stronger security. Examples of key-bearing security tokens include Kerberos v5 tickets with session keys and SAML v1.1 or v2.0 tokens with holder-of-key subject confirmation.

In one type of interaction, a requester acquires a security token from an identity provider. The requester then presents the security token with a request to a relying party, which may be providing a resource. The relying party has a trust relationship with the identity provider that serves as assurance of the authenticity of the security key.

When acquiring a security token from an identity provider, the requester may provide some identification information, such as a username and password. There are many scenarios where an identity provider may require real-time interactions with the requester to supplement authentication credentials submitted in the original request. One way that an identity provider can do this is by challenging the requester to provide additional authentication data. For example, the identity provider may prompt the user with a question to be answered correctly to provide further evidence of authenticity.

WS-Security and WS-Trust are communications protocols defined by OASIS for applying security to Web services. They are designed to work with Simple Object Access Protocol (SOAP) protocols. The security token services (STS) framework, defined by WS-Trust, allows for a simple request/response pattern for requesting security tokens, as well as an extension mechanism to enable exchanges for negotiation and challenges.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to authenticate a request for a resource sent from a requester to a challenger. In an example embodiment, the request is sent in a first protocol. The challenger may receive the request and generate and send a challenge message to the requester in the first protocol. The challenge message may include a URI indicating an address of a challenge server. In response to receiving the challenge message, the requester may instantiate a challenge handler and convey the URI to the challenge handler. The challenge handler may use the URI to connect to the challenge server and begin an interactive challenge in a second protocol. If the interactive challenge is successful, the challenge server may send to the challenge handler a message including a Web token indicating a successful interactive challenge. The challenge handler may convey the Web token to a request client. The request client may send a challenge response message with the Web token indicating a successful interactive challenge. In response, the challenger may selectively provide access to the requested resource, based on whether the challenger response message includes the Web token indicating a successful interactive challenge.

In one example embodiment, the second protocol employs HTML, and the first protocol does not use HTML. The interactive challenge may include sending one or more HTML pages from the challenger to the challenge handler. The challenge handler may send an HTTP GET message, an HTTP POST message, or another message to initiate a communication or to respond to HTML pages. In one embodiment, the first protocol is in accordance with a WS-Trust protocol.

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIGS. 1A-B are block diagrams of environments in which embodiments may be practiced;

FIG. 2 is a block diagram illustrating an example embodiment of a computing system that may be employed to implement a requester;

FIG. 3 is a block diagram illustrating an example embodiment of a computing system that may be employed to implement a challenger;

FIG. 4 illustrates an example environment in which an interactive challenge may be practiced; and

FIGS. 5A-B are a flow diagram illustrating an example embodiment of a process of employing a challenge in a second communication channel to authenticate a request in a first communication channel.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “fan,” and “the” include plural references. The meaning of “in” includes “in” and “on.”

As used herein, the term “authenticate” refers to confirming that facts or claims are true, to an acceptable degree of certainty. Authenticating a user or a user's identity applies to confirming that the stated identity of the user is sufficient and accurate. Authenticating a request from a user may include confirming that the identity information included with the request is accurate, that the request originated with or is authorized by the identified user, or that other information in the request is accurate. Authentication has an associated degree of certainty, allowing for a situation in which information has been authenticated yet may be inaccurate.

The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

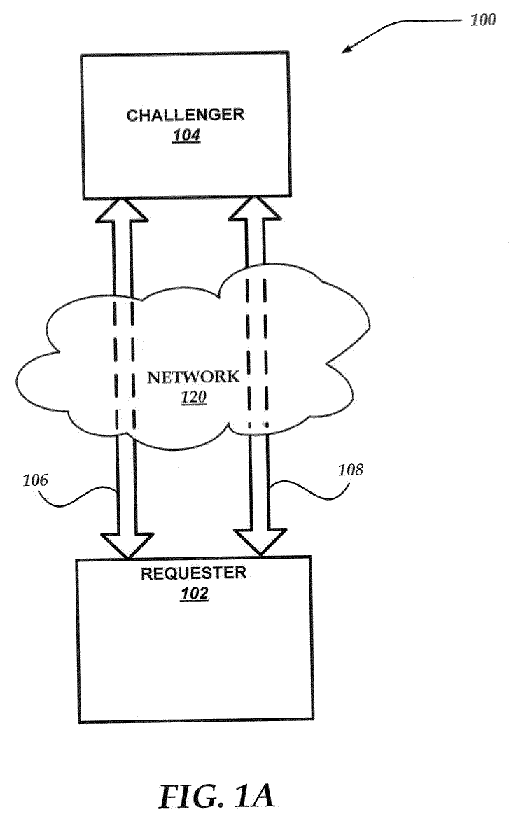

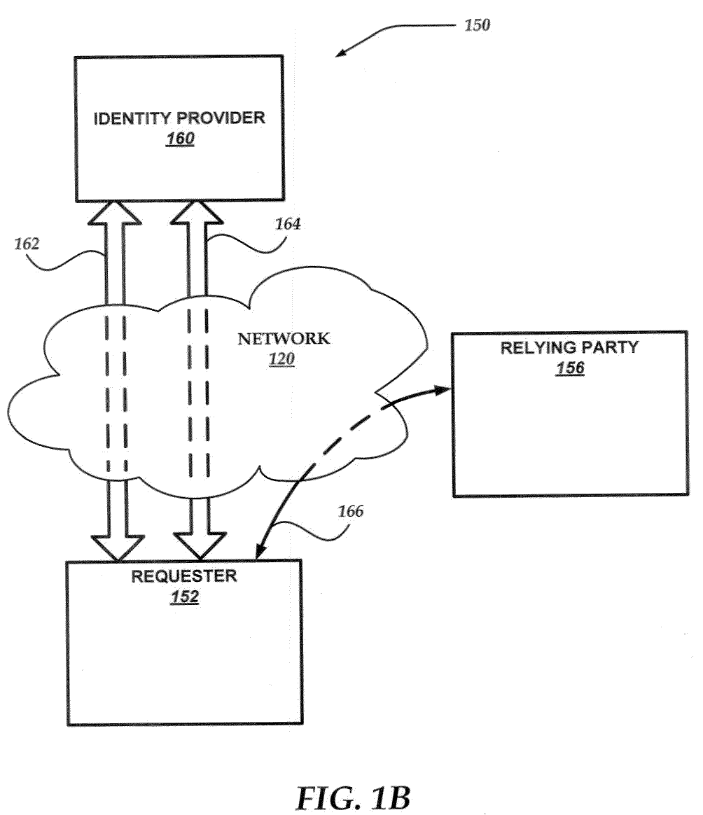

FIG. 1A is a block diagram of an example environment 100 in which embodiments may be practiced. FIG. 1A provides a basic understanding of an example environment, though many configurations may be employed and many details are not illustrated in FIG. 1A. As illustrated in FIG. 1A, an example environment 100 includes a requester 102. Requester 102 may be a client computing device, process, or any component that requests resources or services from another entity. As used herein, a service is considered to be a resource and is thus included in references to resources.

Example environment 100 includes challenger 104. Challenger 104 may be a computing device, a server or a server farm that includes multiple servers. In one embodiment, challenger 104 is a process executing on a computing device. Challenger 104 may, in response to requests from requester 102, provide a resource.

As illustrated in FIG. 1A, requester 102 and challenger 104 may communicate with each other through a network 120. Network 120 may include a local area network, a wide area network, or a combination thereof. In one embodiment, network 120 includes the Internet, which is a network of networks. Network 120 may include wired communication mechanisms, wireless communication mechanisms, or a combination thereof. Communications between requester 102 and challenger 104, with each other or other computing devices may employ one or more of various wired or wireless communication protocols, such as IP, TCP/IP, UDP, HTTP, SSL, TLS, FTP, SMTP, WAP, Bluetooth, WLAN.

In one embodiment, requester 102 and challenger 104 employ two communication channels to communicate with each other. As represented by arrows, request channel 106 may enable requester 102 and challenger 104 to communicate messages related to a request and response; challenge channel 108 may enable requester 102 and challenger 104 to communicate messages related to a challenge. These channels and messages are discussed in further detail herein.

In one embodiment, requester 102 sends one or more requests to challenger 104, employing request channel 106. A request may include some type of identifying information. Challenger 104 may process the request and determine whether the request includes information to sufficiently authenticate the request or a user of requester 102. In some situations, challenger 104 may determine that a stronger authentication than the provided identifying information is required. Challenger 104 may inform requester 102 of a challenge. In one embodiment, requester 102 and challenger 104 employ challenge channel 108 to perform an interactive challenge. In one embodiment, an interactive challenge uses the HyperText Markup Language (HTML) protocol to communicate over HTTP. Mechanisms and content of challenges are discussed in further detail herein.

FIG. 1B is a block diagram of an environment 150 in which embodiments may be practiced. Environment 150 is a more specific example of environment 100, and the discussion of environment 100 is applicable to environment 150. As illustrated in FIG. 1B, an example environment 150 includes requester 152, which may be requester 102.

Example environment 150 includes relying party 156. Relying party 156 may be a computing device, server, or a server farm that includes multiple servers.

In one embodiment, requester 152 sends one or more requests to relying party 156. A request may include some type of identifying information. Relying party 156 may process the request and determine whether the request includes information to sufficiently identify requester 152. This information may be referred to as security credentials. If the security credentials are not included in the request, or are insufficient, relying party 156 may reject the request and instruct requester 152 to provide sufficient security credentials.

Example environment 100 includes identity provider 150. Identity provider 160 is a network entity that provides security credentials to requesting entities, such as requester 152. The security credentials may represent claims about requester 152 that can be trusted by relying party 156. Thus, identity provider 160 is considered to be a trusted party by relying party 156. In one embodiment, the security credentials include a security token, and identity provider 160 includes a security token service that provides security tokens. In one embodiment, challenger 104 is identity provider 160.

A security token includes data that represents a collection of one or more claims about an entity, such as a user of requester 152. The claims may be considered as assertions that information associated with the claimer is accurate. This may include, for example, a name, identifier, key, group membership, a privilege, a capability, or the like. In some embodiments, a security token includes one or more cryptographic keys.

Requester 152 may communicate with relying party 156 or identity provider 160 through network 120. In one embodiment, requester 152 communicates with identity provider 160 over a first communication channel, and also communicates with identity provider 160 over a second communication channel, as discussed with respect to FIG. 1A. As represented by arrows, requester 152 and identity provider 160 communicate messages related to a request and response over request channel 162; requester 152 and identity provider 160 communicate messages related to an interactive challenge over challenge channel 164.

FIGS. 1A-B are only examples of suitable environments and are not intended to suggest any limitation as to the scope of use or functionality of the present invention. Thus, a variety of system configurations may be employed without departing from the scope or spirit of the present invention. For example, any of the functions of challenger 104, identity provider 160, requesters 102 or 152, or relying party 156 may be combined into one or more computing devices, distributed, or replicated among multiple computing devices in a variety of ways.

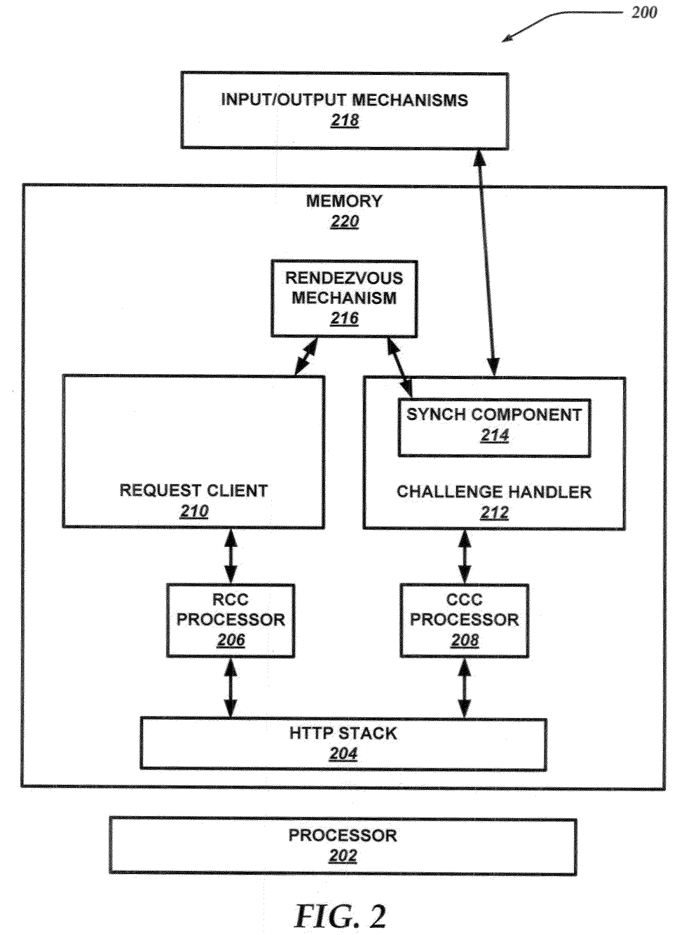

FIG. 2 is a block diagram illustrating an example embodiment of a computing system 200 that may be employed to implement requester 102 or 152, or portions thereof.

As illustrated, computing system 200 includes one or more processors 202 that perform actions to execute instructions of various computer programs. In one configuration, processor 202 may include one or more central processing units, one or more processor cores, an ASIC, or other hardware processing component and related program logic. In the illustrated embodiment, computing system 200 includes memory 220, which may comprise volatile or non-volatile memory. In one embodiment, HTTP stack 204, RCC processor 206, CCC processor 208, request client 210, and challenge handler 212 reside in memory 220.

In the illustrated embodiment, computing system 200 includes HTTP stack 204. An HTTP stack is a component that includes program instructions configured to perform actions of receiving, processing, and sending hypertext protocol (HTTP) messages, in accordance with HTTP standards and with at least some of the mechanisms described herein.

In one embodiment, computing system 200 includes a request communication channel (RCC) processor 206 and a challenge communication channel (CCC) processor 208. Each of RCC processor 206 and CCC processor 208 performs actions to implement a respective communication channel. As used herein, a communication channel is defined by the protocols that it employs to communicate messages with another entity and the protocol of the payload that the messages carry. For example, in one embodiment, RCC processor 206 sends, receives, and processes HTTP messages carrying XML content. In one embodiment, CCC processor 208 sends, receives, and processes HTTP messages carrying HTML content. A channel that includes HTTP messages carrying eXtensible Markup Language (XML) content is distinguishable from a channel that includes HTTP messages carrying HTML content, and is therefore considered to be a different channel from the HTML channel.

In one example embodiment, RCC processor 206 sends, receives, and processes messages in a hierarchically structured format (at least at the application level), such as a Simple Object Access Protocol (SOAP) envelope structured using XML, although that need not be the case. An example is a SOAP message in which header information is often provided in accordance with WS-Security, and much of the body is structured in accordance with WS-Trust.

Each of RCC processor 206 and CCC processor 208 may include hardware, software, or a combination thereof, and may comprise a program, library, or a set of instructions.

In one embodiment, computing system 200 includes request client 210. Request client 210 may perform actions of communicating requests to challenger 104, receiving responses, and other actions, some of which are described herein. In one embodiment, request client 210, in response to receiving a challenge message, instantiates challenge handler 212.

In one embodiment, computing system 200 includes challenge handler 212, which may perform actions of enabling a user to interact with challenger 104. In one embodiment, challenge handler 212 is an HTML client that receives and renders HTML, receives input from a user, and communicates HTTP messages to challenger 104. An HTML client renders HTML pages and accepts user input as part of an interaction with one or more Web pages. A Web browser is one example of an HTML client, though an HTML client may be implemented in a variety of ways other than as a Web browser. In one example embodiment, challenge handler 212 is a commercially available Web browser, such as Internet Explorer®, by Microsoft Corporation, of Redmond, Wash. In one embodiment, challenge handler 212 may facilitate transmitting audio messages between a user and challenger 104.

In one embodiment, request client 210 may employ RCC processor 206 to send and receive messages to and from challenger 104. RCC processor 206 may, in turn, employ HTTP stack 204 to send and receive messages to and from challenger 104. In one embodiment, challenge handler 212 may employ CCC processor 208 to send and receive messages to and from challenger 104. Challenge processor 208 may employ HTTP stack 204 to send and receive messages to and from challenger 104. Thus, as can be seen in the illustrated embodiment of FIG. 2, request client 210 and challenge handler 212 each employ a communication channel and a corresponding protocol that is distinguishable from the other.

In one embodiment, computing system 200 includes synchronization component 214. In particular, challenge handler 212 may include, be integrated with, or employ services of synchronization component 214. Synchronization component 214 may perform actions to facilitate synchronization of actions between challenge handler 212 and request client 210. In one embodiment, synchronization component 214, or a portion thereof, may be a software control such as an ActiveX control or a java applet that is received in an HTTP message.

In one embodiment, computing system 200 includes rendezvous mechanism 216. Rendezvous mechanism 216 may be any mechanism that allows challenge handler 212 to synchronize one or more of its actions with, or to pass data to, request client 210. Some examples of rendezvous mechanism 216 are a shared file, a shared block of memory, an interprocess signal, or a system service that enables interprocess communication. As discussed herein, challenge handler 212 may use rendezvous mechanism 216 to notify request client 210 that an interactive challenge is complete, or to pass token information to request client 210. Rendezvous mechanism 216 serves to bridge a request process with a challenge process, each process employing different communication channels.

In one embodiment, computing system 200 includes input/output mechanisms 218 that enable a user to interact with the computing system, and specifically with challenge handler 212. In various embodiments, input/output mechanisms 218 may include a display, touch-screen, keyboard, mouse or other pointing device, audio speaker, microphone, camera, or other mechanism, or a combination thereof.

Example computing devices that may be used to implement computing system 200 include mainframes, servers, blade servers, personal computers, portable computers, communication devices, consumer electronics, or the like. A computing device may include a general or special purpose operating system that provide system services to request client 210 and challenge handler 212, as well as other components. The Windows® family of operating systems, by Microsoft Corporation, of Redmond, Wash., are examples of operating systems that may execute on a computing device of a computer system 200.

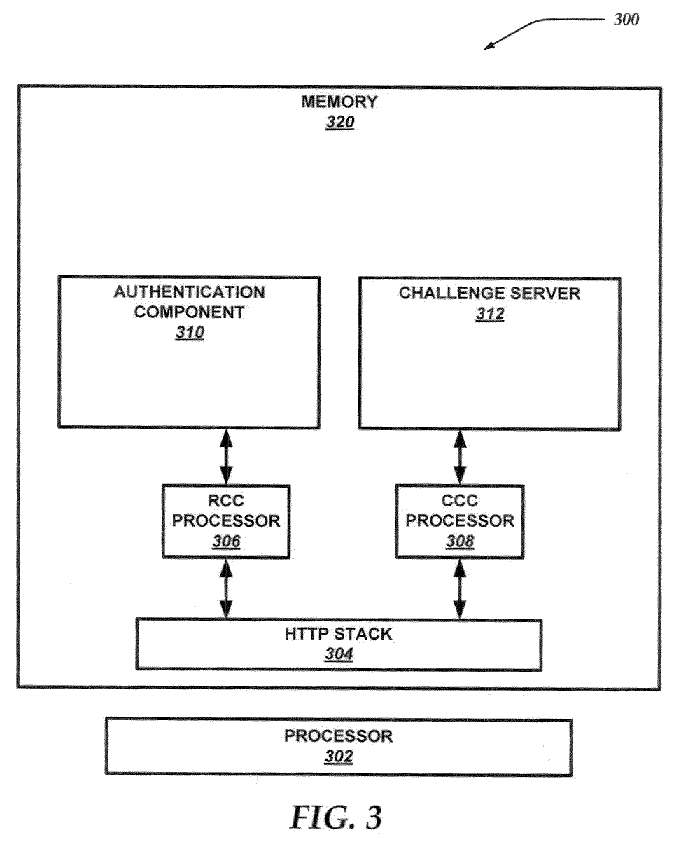

FIG. 3 is a block diagram illustrating an example embodiment of a computing system 300 that may be employed to implement challenger 104, identity provider 160, or portions thereof.

As illustrated, computing system 300 includes one or more processors 302, HTTP stack 304, RCC processor 306, and CCC processor 308. Each of these components are similar to corresponding processors 302, HTTP stack 204, RCC processor 206, and CCC processor 208 of FIG. 2, and the descriptions with respect to FIG. 2 apply to the corresponding components of FIG. 3, though the implementation of each may differ. Computing system 300 includes memory 320, which may comprise volatile or non-volatile memory. In one embodiment, HTTP stack 304, RCC processor 306, CCC processor 308, authentication component 310, and challenge server 312 reside in memory 320.

In one embodiment, computing system 300 includes authentication component 310. Authentication component 310 may perform actions of receiving requests from requesters, authenticating the requesting user, determining authentication requirements, notifying requesters of authentication requirements or challenges, and other actions, some of which are described herein.

In one embodiment, computing system 300 includes challenge server 312, which may perform actions of implementing a challenge to a requester. In one embodiment, challenge server 312 is an HTML server that generates and sends HTML content, receives input from a requesting device, and communicates HTTP messages to a requester. Challenge server 312 may send scripts or program objects, such as activeX objects, to a requester. In one embodiment, challenge server 312 may facilitate transmitting or receiving audio messages to or from a requester.

In one embodiment, authentication component 310 may employ RCC processor 306 to send and receive messages to and from requester 102 or 152. RCC processor 306 may, in turn, employ HTTP stack 304 to send and receive messages to and from requester 102 or 152. In one embodiment, challenge server 312 may employ CCC processor 308 to send and receive messages to and from requester 102 or 152. Challenge server 312 may employ HTTP stack 304 to send and receive messages to and from requester 102 or 152. Thus, as can be seen in the illustrated embodiment of FIG. 3, authentication component 310 and challenge server 312 each employ a communication channel and a corresponding protocol that is distinguishable from the other.

Example computing devices that may be used to implement computing system 300 include mainframes, servers, blade servers, personal computers, portable computers, communication devices, consumer electronics, or the like. In one embodiment, authentication component 310 and RCC processor 306 may reside on a different computing device from challenge server 312 and CCC processor 308. The elements of computer system 300 may be duplicated or distributed among one or more computing devices in various configurations. A computing device may include a general or special purpose operating system that provides system services to authentication component 310 and challenge server 312. The Windows® family of operating systems, by Microsoft Corporation, of Redmond, Wash., are examples of operating systems that may execute on computing system 300.

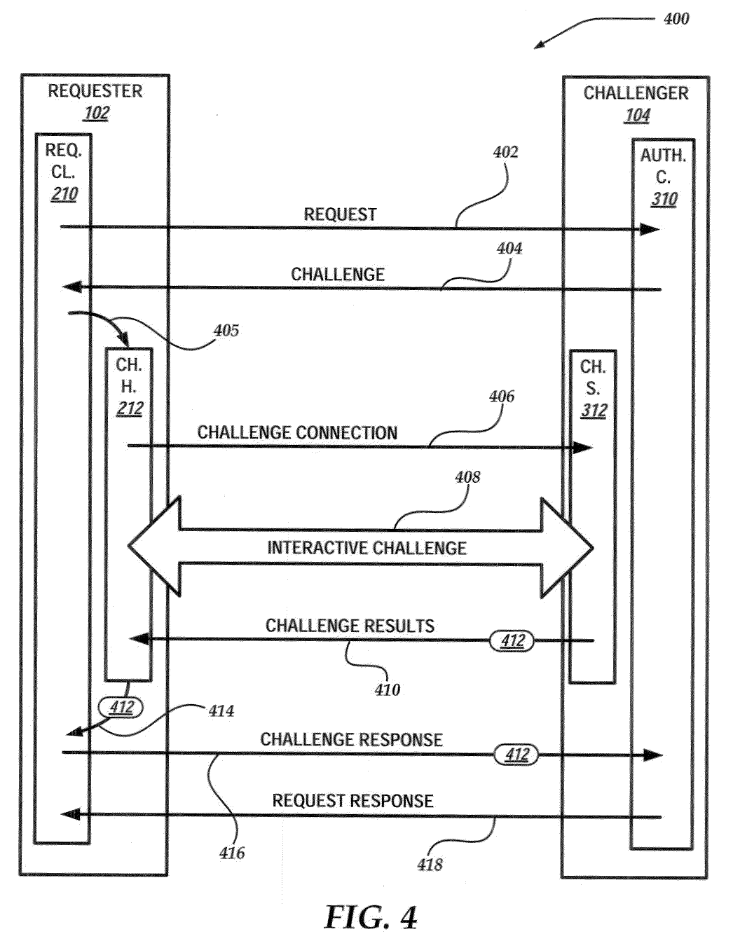

FIG. 4 illustrates an example environment 400 in which an interactive challenge may be practiced. Environment 400 may exist in conjunction with environment 100 of FIG. 1A, environment 150 of FIG. 1B, or a variation thereof. As illustrated, environment 400 includes requester 102 and challenger 104. Requester 102 includes request client 210 and challenge handler 212. Challenger 104 includes authentication component 310 and challenge server 312. Requester 102 is in direct or indirect communication with challenger 104. The communication may be direct or over a network, such as network 120.

Arrows in FIG. 4 represent messages that are sent or received from one of the illustrated components. Moreover, in one embodiment, the reference numbers of the messages correspond to a temporal sequence in a direction from the top toward the bottom of the figure, though in various embodiments, the sequence differs. In one embodiment, each of the illustrated messages is an HTTP message, the content of which are described in more detail below.

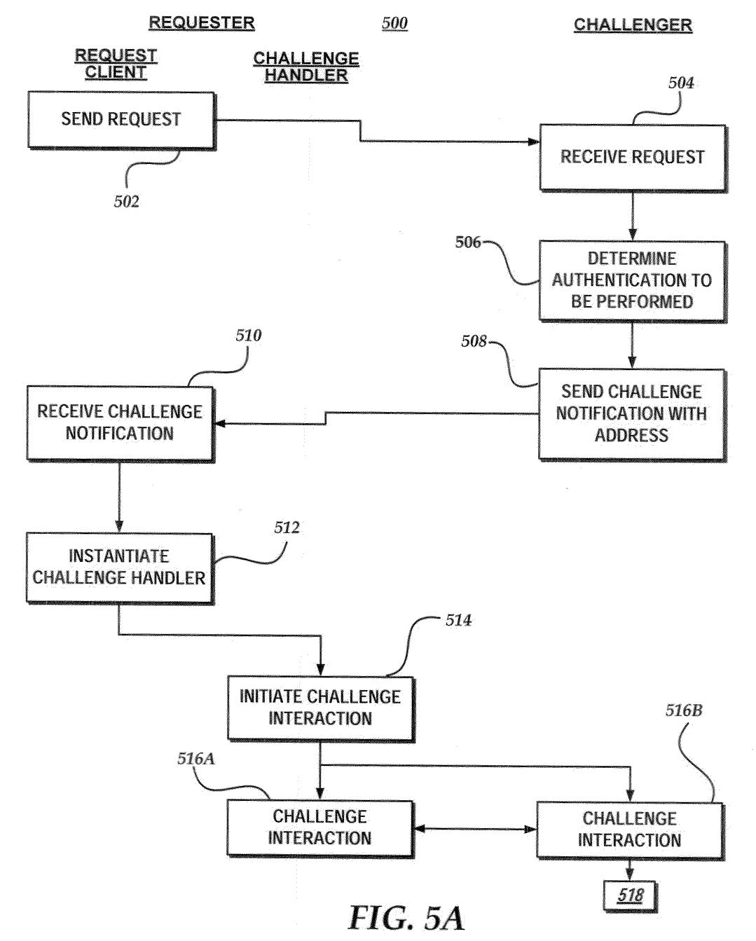

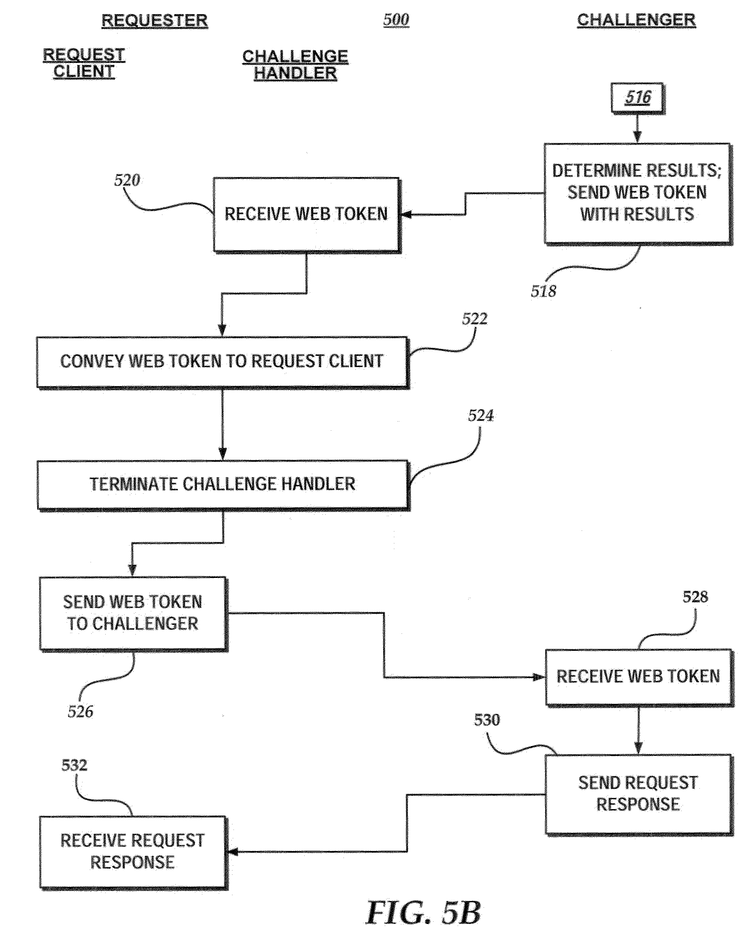

The messages of FIG. 4 are discussed in conjunction with FIGS. 5A-B. FIGS. 5A-B present a flow diagram illustrating an example embodiment of a process 500 of employing a challenge in a second communication channel to authenticate a request in a first communication channel. Some of the actions of process 500 are performed by requester 102 (FIGS. 1A-B), and are represented in the left column of FIGS. 5A-B under the header “Requester.” Some of these actions may be performed by request client 210, and are represented in the left sub-column of FIGS. 5A-B under the header “Request Client.” Other requester actions may be performed by challenge handler 212, and are represented in the right sub-column of FIGS. 5A-B under the header “Challenge Handler.” Other actions of process 500 are performed by challenger 104, and are represented in the right column of FIGS. 5A-B under the header “Challenger.” Some of the actions of process 500 relate to sending or receiving messages illustrated in FIG. 4. The following discussion references messages and components of FIG. 4.

The illustrated portions of process 500 may be initiated at block 502, where request client 210 sends a request message to challenger 104 (Request message 402). In one embodiment, request message 402 is a request for a resource for which access is protected by an authentication process. In one example embodiment, the requested resource is a security token. The request may include various information, such as an identity of a resource associated with the security token, one or more claims relating to requester 102 that are to be included in the security token, or other information. In one embodiment, request message 402 includes a RequestSecurityToken element defined by WS-Trust.

The process may flow from block 502 to block 504, where challenger 104 may receive the request message 402. Process 500 may flow from block 504 to block 506, where a determination is made of an interactive challenge that is to be performed in order to properly authenticate the request sent from requester 102, based on a number of factors. In one embodiment, at block 504, challenger 104 may perform a preliminary authentication based on identity information received with request message 402. For example, request message 402 may include a username and password, which is authenticated by challenger 104.

The determination of what interactive challenge to employ may be based on one or more of a number of factors. One example of a factor includes the value of the resource requested by requester 102. In the example environment 150, relying party 156 may specify that requester 152 provide a security token with one or more claims about requester 152. The claims may be considered as assertions that information associated with the claimer is accurate. This may include, for example, a name, identifier, key, group membership, a privilege, a capability, or the like. In one embodiment, a challenger, such as identity provider 160, includes a policy store that is configured to govern interactive challenges corresponding to a type of token requested and the type of claims. In an environment without a separate relying party, challenger 104 may consider any one or more of these factors. Other factors that may be considered include characteristics of the requester or user, such as a group membership, the requester's location, type of computing device implementing requester 102, time of day, history of requests by the requester or user, or history of challenges used with the requester or user.

Challenger 104 may determine, based on a level or type of challenge to be issued, an implementation of the challenge. Challenger 104 may have available a number of challenges that can satisfy the level of challenge to be issued. One example includes one or more HTML pages that ask one or more questions. Another example includes presenting a user with content such as images, graphics, video, or animation in one or more HTML pages, and instructing the user to perform an action or answer a question with respect to the content. For example, a user may be asked to identify a person in an image by entering a name or other identifier, click on a location in an image, identify a location associated with an image, manipulate pieces on a displayed chess board or other game, or other such actions. An HTML page may instruct a user to manipulate images, play a game, respond to an audio or video presentation, or the like. In one embodiment, challenges may include virtually any type of interaction that may be performed with a Web browser or other type of challenge handler that renders HTML pages, and enables user input. An interaction may employ scripts or controls that are sent from challenger 104. Thus, the types of challenge may include complex user interfaces. In particular, challenge handler does not need to be configured with the range of user interfaces or interactive challenges that may be used.

In one embodiment, at block 508, challenger 104 generates and sends to requester 102 a challenge message 404 that serves to notify requester 102 of a challenge and a mechanism for initiating the challenge. In one embodiment, the mechanism includes a connection point for a communication channel, or more specifically, an address of challenge server 312. In one embodiment, the mechanism includes a uniform resource identifier (URI) or uniform resource locator (URL) that may be used to access a challenge server. The message may include data that identifies a context of the challenge, such as user identification, an identification of the challenge to be performed, a requested security token, a timestamp, or other context information, or any combination thereof. In one embodiment, at least some of the context information is encoded in a URI sent to the requester.

Process 500 may flow from block 508 to block 510, where request client 210 receives challenge message 404. The process may flow to block 512, where, in response to receiving challenge message 404, request client 210 may instantiate challenge handler 212. In one embodiment, instantiating challenge handler 212 may include creating a process that comprises challenge handler 212. In one embodiment, a challenge handler process may be executing, and instantiating a challenge handler may include sending a signal to the process to create a new window, a new tab, or another viewer component that may display pages to a user.

In one embodiment, the actions of block 512 include conveying to challenge handler 212 at least a portion of the contents of challenge message 404, the portion including a mechanism for initiating a challenge. The mechanism may include, for example, a URI. Request client 210 may convey context information received with challenge message 404, as described herein. Arrow 405 represents the conveying of context information to challenge handler 212.

Process 500 may flow from block 512 to 514, where challenge handler 212 initiates an interactive challenge with challenger 104 by connecting to a challenge connection point. The identification of the connection point may be received from challenger 104 in challenge message 404, for example in the form of a URI. The actions of block 514 may include establishing a TCP connection with the connection point. In one embodiment, the connection point corresponds to an address of challenge server 312. Initiation of the interactive challenge may include sending a challenge connection message 406 from challenge handler 212 to challenge server 312. The interactive challenge may employ CCC processor 208 (FIG. 2) and CCC processor 308 (FIG. 3) in conjunction with challenge channel 108 (FIG. 1A).

In one embodiment, a URI in challenge message 404 may contain additional information that facilitates challenger 104 or challenge server 312 in establishing an interactive challenge, including determining the content and mechanisms of the challenge. In one implementation, a URI may contain at least a portion of context information received by request client 210 in challenge message 404. In one embodiment, challenge connection message 406 may include an HTTP request such as an HTTP “GET” method, based on the URI. Context information may be received in a form other than a URI. In one embodiment, challenge connection message 406 includes an HTTP request with an HTTP “POST” method, based on the URI and including at least a portion of received context information in data that is sent in a message body with the “POST” message.

Though not illustrated in FIG. 4 or 5, in some implementations, multiple challenge connection messages 406 may be sent in order to initialize an interactive challenge. For example, challenger 104 may respond to an initial challenge connection message 406 by sending an HTTP “redirect” message, instructing challenge handler 212 to send another HTTP message with a different URL. In one embodiment, the interactive challenge may be performed within a Secure Sockets Layer (SSL) or Transport Layer Security (TLS) communication, which may be set up at block 514.

Process 500 may flow from block 514 to 516a and 516b, where an interactive challenge is performed, as represented by interactive challenge messages 408. An interactive challenge may include any number of interactive challenge messages 408 exchanged between requester 102 and challenger 104 and more specifically, between challenge handler 212 and challenge server 312. As discussed herein, an interactive challenge may include one or more HTML pages sent from challenge server 312 to challenge handler 212 and corresponding interactive challenge messages sent in response, and may include virtually any type of HTML-based interaction. In particular, requester 102 and challenge handler 212 do not need to be configured with information of a limited number of choices for interaction formats. In one embodiment, upon receiving a response from challenge handler 212, challenge server 312 may determine a next HTML page to send based on the response. In one embodiment, an interactive challenge may employ a communication channel with a protocol other than HTML, but different from the request communication channel employed by request client 210.

In one embodiment, each interactive challenge message 408 that is exchanged includes context data. Challenge server 312 may send new context data with each message, the context data indicating a current state of the interaction. Challenge handler 212 may return the received context data in its next message to the challenge server. As discussed herein, context data may be returned within a URL, within the body of an HTTP POST message, or by another mechanism.

By sending context data to challenge handler 212 and receiving it back in a subsequent message, challenge server 312 may be implemented as a stateless machine, in which each interaction request is handled based on the context data it receives, and challenge server 312 does not need to maintain a record of previous interactions with challenge handler 212. In one embodiment, challenge server 312 or authentication component 310 may be distributed across multiple computing devices. The context data in each requester message facilitates this configuration such that each computing device does not need to exchange information relating to a requester.

Process 500 may flow from block 516B to block 518 (FIG. 5B). In one embodiment, at block 518, in response to an interaction with requester 102, challenge server 312 determines results of the interactive challenge, based on the responses received from challenge handler 212. This may include determining a status of success or failure, based on whether the received one or more responses are acceptable. A response may be considered acceptable based on a configuration of challenge server 312, data associated with requester 102 or the requesting user, or on logic of the interactive challenge.

In one embodiment, challenge server 312 sends to challenge handler 212 a challenge results message 410 containing results of the interactive challenge. Results may include a status, such as success or failure, or it may include a more refined status value. Challenge results message may conclude the interactive challenge. The message may include a Web token 412. A Web token includes data that represents context data, including data that identifies or references the request sent by requester 102 in request message 402. Web token 412 may include status data that indicates whether the interactive challenge concluded successfully. In one embodiment, Web token 412 is sent only in response to a successful interactive challenge. Possession of a “success” Web token by requester 102 serves as an indication that the corresponding interactive challenge has been successfully completed. In one embodiment, a Web token includes cryptographically secure data. It may be in any of a variety of formats.

In one embodiment, challenge server 312 sends at least a portion of synchronization component 214 to requester 102. This may occur within the body of one of the interactive challenge messages 408, in challenge response message 416, or in a separate message. Challenge handler 212 may install the synchronization component upon receiving it. In one embodiment, the synchronization component is installed in challenge handler 212 in another manner, such as with the distribution of the challenge handler. Synchronization component 214 may be a script or program object, such as an activeX control.

In one implementation, challenge response message 416 includes an HTML page with an object tag that indicates the tag includes a Web token. An example section of HTML is as follows:

```
<OBJECT
    MimeType = WebToken>
    (WebToken inserted here)
/OBJECT>
```

In one embodiment, in response to receiving this tag, challenge handler 212 invokes a synchronization component, such as program object, that is associated with the specified mime type.

As discussed herein, in one embodiment the receipt of the Web token by challenge handler 212 indicates that the interactive challenge is completed, and also indicates the result of the interactive challenge.

Though not illustrated, an interactive challenge may result in a failure status, based on responses by requester 102. Challenger 104 may send a message to requester 102 as a notification of a failure. In one implementation, this message may be an HTTP error message.

Process 500 may flow from block 518 to block 520, where challenge handler 212 may receive the challenge results message 410 from challenger 104. This message may serve to inform challenge handler 212 that the interactive challenge has successfully concluded. The process may flow to block 522, where challenge handler 212 may convey the Web token 412 to request client 210. This is represented by arrow 414 of FIG. 4.

In one embodiment, rendezvous mechanism 216 may be used to convey information, including Web token 412, from challenge handler 212 to request client 210. Synchronization component 214 may perform at least some of the actions of block 522. As illustrated in FIG. 5B, in one embodiment, the actions of block 522 are performed by request client 210 and challenge handler 212, in which request client 210 performs actions to receive the notification or Web token.

The process may flow from block 522 to block 524, where, in one implementation, challenge handler 212 is terminated. This may be performed by challenge handler 212. In one implementation, request client 210 initiates the termination of challenge handler 212, in response to receiving a notification. In one implementation, at least some of the actions of block 524 may be delayed until a later time. In one embodiment, terminating a challenge handler includes ending a process that comprises the challenge handler. In some embodiments, terminating a challenge handler include closing a window, a tab, or another viewer component.

Process 500 may flow from block 524 to block 526, where requester 102 may send a message to challenger 104 in the request communication channel. This message is referred to as challenge response message 416. Challenge response message 416 may include context information received from challenger 104. It may also include the Web token 412 received by challenge handler 212 and conveyed to request client 210.

Process 500 may flow from block 526 to block 528, where challenger 104 may receive challenge response message 416 with the Web token 412. In one embodiment, this message notifies challenger 104 whether the interactive challenge has been successfully completed. By including context information in challenge response message 416, challenger 104 may be implemented as a stateless machine. The process may flow to block 530, where challenger 104 may send request response message 418 to requester 102. This message may include a response to the original request message 402 sent by requester 102 to challenger 104. For example, in one embodiment, this message includes a security token, as described herein. In some embodiments, request response message 418 may include another type of resource, or a mechanism for obtaining a resource.

In one embodiment, a Web token is not included as part of process 500. For example, challenger 104 may retain the context of its interaction with requester 102, including status information that indicates whether the interactive challenge was successful. Challenge response message 416 may include an identifier that is used by challenger 104 to indentify the requester and the request interaction. It may use this information to determine whether the interactive challenge was successful, and whether to respond accordingly.

The process may flow to block 532, where requester 102 may receive request response message 418. In one embodiment, such as environment 150 of FIG. 1B, requester 102 may send a request to a relying party, the request including a security token received in request response message 418.

In one embodiment, each of request message 402, challenge message 404, challenge response message 416, and request response message 418 is exchanged between request client 210 and authentication component 310. Each of these messages may be sent in a first protocol, employing RCC processor 206 on the requester side and RCC processor 306 on the challenger side.

In one embodiment, each of challenge connection message 406, interactive challenge messages 408, and challenge results message 410 is exchanged between challenge handler 212 and challenger server 312. Each of these messages may be sent in a second protocol, employing CCC processor 208 on the requester side and CCC processor 308 on the challenger side.

In one embodiment, each of request message 402, challenge message 404, challenge response message 416, and request response message 418 is a hierarchically structured message (at least at the application level), such as a Simple Object Access Protocol (SOAP) envelope structured using XML, and each challenge connection message 406, interactive challenge messages 408, and challenge results message 410 includes an HTML page or form. Thus, in one embodiment, each of request client 210 and challenge handler 212 send and receive messages in different protocols from the other. Mechanisms discussed herein provide a way to perform an HTML-based interactive challenge in conjunction with a WS-Trust request framework, the results of the interactive challenge being embedded within the framework of the WS-Trust exchange.

### Example Messages

This section describes examples of message contents that may be used to implement the messages described in environment 400, or other messages. These descriptions are to be understood as a set of examples. In various embodiments, these examples may be used in their entirety or in a subset thereof to form an authentication scheme, or protocol. In various embodiment, keywords or parameters may differ and still be employed to perform at least some of the mechanisms described herein. In one embodiment, none of these examples are used.

Following is a portion of an example challenge message 404, that may be used. In this example, the “WebTokenChallenge” element indicates a challenge and a mechanism for initiating the challenge. The “WebURL” field includes a URL that serves as a connection point for a communication channel, or more specifically, an address of a challenge server 312. The “RelayContext” field includes data that identifies a context of the challenge, as described herein.

```
<S11:Envelope ...>
  <S11:Header> ... </S11:Header>
  <S11:Body>
    <wst:RequestSecurityTokenResponse>
      <WebTokenChallenge xmlns=”...”>
        <RequiredWebToken>
          <WebURL>https://www.contoso.com/sts/interactive</
          WebURL>
          <RelayContext>
Eq9UhAJ8C9K5l4Mr3qmgX0XnyL1ChKs2PqMj0Sk6snw/
IRNtXqLzmgbj2Vd3vFA4Vx1hileSTyq
        </RelayContext>
      </RequiredWebToken>
    </WebTokenChallenge>
  </wst:RequestSecurityTokenResponse>
</S11:Body>
</S11:Envelope>
```

Following is a portion of an example challenge connection message 406, that may be used. In this example, an HTTP POST is employed. In this example, the RelayContext element includes the data from the challenge message 404.

POST /sts/interactive HTTP/1.1
Host: www.contoso.com
...
<RelayContext>
Eq9UhAJ8C9K5l4Mr3qmgX0XnyL1ChKs2PqMj0Sk6snw/
IRNtXqLzmgbj2Vd3vFA4Vx1hileSTy
</RelayContext>

Following is a portion of an example challenge results message 410 that may be used. In this example, a Web token is included using a defined object tag.

```
HTTP/1.1 200 OK
Content-Type: text/html
...
<html>
  <body>
    <OBJECT type=“application/x-webToken”>
      <PARAM Name=“WebToken”
Value=“kAsskqpqBc4bMHT61w1f0NxU10HDor0DlNVcVDm/
AfLcyLqEP+oh05B+5ntVIJzL8Ro3typF0eoSm”>
    </OBJECT>
  </body>
</html>
```

Following is a portion of an example challenge response message 416 that may be used. In this example, the Web token from the challenge results message 410 is included in the WebToken element.

```
<S11:Envelope ...>
  <S11:Header>
  ...
  </S11:Header>
  <S11:Body>
  <wst:RequestSecurityTokenResponse>
    <WebTokenChallengeResponse xmlns=”...”>
    <WebToken>
kAsskqpqBc4bMHT61w1f0NxU10HDor0DlNVcVDm/
AfLcyLqEP+oh05B+5ntVIJzL8Ro3typ F0eoSm
    </WebToken>
    </WebTokenChallengeResponse>
  </wst:RequestSecurityTokenResponse>
  </S11:Body>
</S11:Envelope>
```

It will be understood that each block of the flowchart illustrations of FIGS. 5A-B, and combinations of blocks in the flowchart illustrations, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A computer-readable storage medium comprising computer program instructions for obtaining a resource, the program instructions executable by a processor to perform actions including:
a) sending a request message to an authenticating server in a first communication channel, the request message representing a request for the resource;
b) receiving a challenge message in the first communication channel, the challenge message including a location of a challenge server;
c) in response to receiving the challenge message, enabling an HTML client to perform an interactive challenge with the challenge server in a second communication channel by conveying the location to the HTML client;
d) receiving, from the HTML client, context data descriptive of a status of the interactive challenge performed by the HTML client with the challenge server;
e) in response to receiving the context data, sending a message to the authenticating server in the first communication channel;
wherein the first communication channel does not include HTML messages.

2. The computer-readable storage medium of claim 1, the context data received by the HTML client from the challenge server in the second communication channel.

3. The computer-readable storage medium of claim 1, the first communication channel employing an XML protocol in accordance with a WS-Trust protocol.

4. The computer-readable storage medium of claim 1, the actions further including performing the interactive challenge in the second communication channel and receiving the context data from the challenge server in the second communication channel.

5. The computer-readable storage medium of claim 1, the actions further including performing the interactive challenge in the second communication channel, performing the interactive challenge comprising receiving one or more HTML pages, rendering the one or more HTML pages, and responding to the one or more HTML pages, wherein interactive challenge is not configured on the HTML client prior to the interactive challenge.

6. A computer-implemented method for authenticating a request from a requesting device, comprising:
a) receiving a request message from the requesting device, the request message received in a first communication channel employing an XML protocol, the request message requesting a resource;
b) in response to receiving the request message, determining an interactive challenge to be performed;
c) generating a challenge message including a context data that identifies the interactive challenge and a challenge server URL indicating an address of a challenge server;
d) sending the challenge message to the requester in the first communication channel;
e) performing the interactive challenge with the requester in a second communication channel employing an HTML protocol, the interactive challenge comprising at least one HTML page that is sent to the requester and at least one response received from the requester;
f) selectively sending the requester, in the second communication channel, a message indicating a successful interactive challenge, based on the at least one response;
g) receiving, in the first communication channel, a challenge response message from the requester;
h) in response to receiving the challenge response message, selectively providing the resource to the requester based on whether the challenge response message indicates the successful interactive challenge.

7. The computer-implemented method of claim 6, wherein the request message, the challenge message, and the challenge response message are in accordance with a WS-Trust protocol.

8. The computer-implemented method of claim 6, the request message indicating a successful interactive challenge including a Web token that indicates the successful interactive challenge and represents context data.

9. The computer-implemented method of claim 6, wherein the resource is a cryptographically secure security token.

10. The computer-implemented method of claim 6, the challenge message further including context data representative of the determined interactive challenge, the method further comprising receiving from the requester at least one of an HTTP POST message including the context data or an HTTP GET message including the context data in a URL.

11. The computer-implemented method of claim 6, further comprising sending to the requester a synchronization component comprising instructions to facilitate synchronizing a first requester component that communicates in the first communication channel with a second requester component that communicates in the second communication channel.

12. The computer-implemented method of claim 6, further comprising enabling an administrator to provide the interactive challenge, the interactive challenge not limited to a set of interactive challenges configured on the requester prior to the interactive challenge.

13. A computer-implemented method for authenticating a request from a requesting device, comprising performing the method of claim 6 as a stateless machine, without storing data descriptive of a status of the interactive challenge prior to selectively providing the resource.

14. A computer-based system for obtaining a resource, comprising:
a) a request client that sends a request message representing a request for the resource to a request server, the request message in accordance with a first protocol;
b) a challenge handler that exchanges a plurality of interactive challenge messages with a challenge server, the interactive challenge messages in accordance with a second protocol different from the first protocol;
wherein the request client performs additional actions including:
i) in response to receiving a challenge message including a URL from the request server, conveying the URL to the challenge handler;
ii) receiving, from the challenge handler, data representing a successful interactive challenge;
iii) sending, to the request server, the data representing the successful interactive challenge;
and wherein the challenge handler performs additional actions including:
i) employing the URL to perform an interactive challenge with the challenge server, the interactive challenge comprising receiving at least one interactive challenge message of the plurality of interactive challenge messages and sending at least one response;
ii) receiving, from the challenge server, the data representing the successful interactive challenge; and
iii) conveying, to the request client, a request response message with the data representing the successful interactive challenge.

15. The system of claim 14, wherein the first protocol is an XML-based protocol in accordance with a WS-Trust protocol, and the second protocol is HTML.

16. The system of claim 14, wherein the challenge handler is an HTML client, the at least one interactive challenge message includes at least one HTML page, and the request message, the challenge message, and the request response message do not include HTML data.

17. The system of claim 14, the additional actions of the challenger server further comprising receiving a synchronization component from the challenger server and employing the synchronization component to convey the data representing the successful interactive challenge to the request client.

18. The system of claim 14, the additional actions of the challenger server further comprising rendering the at least one HTML page, receiving user input, and sending the user input in the at least one response to the HTML.

19. The system of claim 14, the additional actions of the challenge handler further comprising rendering an HTML user interface without prior configuration of the HTML user interface type.

20. The system of claim 14, the additional actions of the challenge handler further comprising exchanging audio data with the challenge server.
